(19) United States
(12) Patent Application Publication
(10) Pub. No.: US 2016/0025187 A1
(43) Pub. Date: Jan. 28, 2016

(54) PLANETARY GEAR SYSTEM

(71) Applicant: Caterpillar Inc., Peoria, IL (US)

(72) Inventors: Timothy S. Stoakes, Naperville, IL (US); Daniel P. Vertenten, Aurora, IL (US)

(73) Assignee: CATERPILLAR INC., Peoria, IL (US)

(21) Appl. No.: 14/340,782

(22) Filed: Jul. 25, 2014

(51) Int. Cl. F16H 1/28; F16H 57/08

(52) U.S. Cl. CPC F16H 1/2809; F16H 57/082; F16H 2001/2881; F16H 2057/0056

(57) ABSTRACT

A planetary gear system with floating components includes design features that center the floating components radially and reduces sagging of the floating components under the force of gravity. An input carrier is centered by the use of an annular bearing in a distal central opening of the input carrier and a stationary end cap assembly that is received in the annular bushing. The bushing and end cap assembly support the input carrier radially. The stationary output carrier is centered by providing a pilot on the output carrier that is received in a circumferential recess in a fixed component, such as a reaction hub.

### BACKGROUND

1. Technical Field

This disclosure relates to transmission mechanisms and more particularly, to a planetary gear system or a planetary speed reducer.

2. Description of the Related Art

Many mechanisms employ planetary gear systems, which transmit rotation of an input component to an output component. Planetary gear systems may reduce or increase the speed of the output component and reduce or increase the torque transmitted to the output component. The drive arrangement between a hydraulic motor and a wheel of a vehicle is one example of a mechanism that employs planetary gear systems.

Common planetary gear systems may include a stationary planet gear carrier coupled to one or more planet gears. The planet gears enmesh with a central sun gear that connects to the input shaft or input component. Rotation of the input shaft causes to the sun gear to rotate about the primary axis (i.e., the axis of the input shaft) and the planet gears to rotate about their respective secondary axes (i.e., the axes of the pins or posts that couple the planet gears to the carrier). The planet gears enmesh with and impart rotation to an outer ring gear. The outer ring gear connects to the output component. For greater speed reduction and/or torque increase, some planetary gear systems may include a second planet gear carrier, a second set of planet gears, a second “floating” sun gear and either a second ring gear or an output set of teeth on the ring gear for enmeshing with the teeth of the second set of planet gears.

One problem associated with planetary gear systems lies in the effect of gravity on “floating” components of a planetary gear system, or components that are not secured to the input shaft. Specifically, the carriers of the planet gears are not secured to the input shaft and therefore can sag downward or radially thereby creating a decentralization of the planet gears with respect to the ring gears(s). Because of this decentralization, unequal load sharing amongst the planet gears may occur at the ring gear teeth, which can lead to catastrophic gear failure. U.S. Pat. No. 3,906,818 and U.S. Pat. No. 5,113,084 disclose planetary gear systems with various design elements that limit axial movement of the planet gear carriers along the primary axis. However, a need exists for a means for limiting radial movement of the planet gear carriers.

### SUMMARY OF THE DISCLOSURE

In one aspect, a planetary gear system is disclosed. The disclosed planetary gear system may connect to a fixed component. The disclosed planetary gear system may include an input component having a primary axis and that couples to an input gear set. The input gear set may mesh with an input set of teeth of a ring gear that surrounds the input gear set. The ring gear may include an output set of teeth. The output set of teeth may mesh with at least one output planet gear. The at least one output planet gear may be rotatably coupled to a stationary output carrier. Further, the stationary output carrier may couple to the fixed component with a pilot received in a circumferential recess that is transverse to the primary axis.

In another aspect, a planetary gear system is disclosed that may include a fixed component. The disclosed planetary gear system may also include an input component having a primary axis and that may couple to an input sun gear. The input sun gear may mesh with at least one input planet gear. The at least one input planet gear may be rotatably coupled to an input carrier. The at least one input planet gear may also be rotatable about a secondary axis. The input carrier may couple to the input component for rotation of the primary axis. The at least one input planet gear may be meshed with an input set of teeth of a ring gear that surrounds the at least one input planet gear and the input carrier. The ring gear may include an output set of teeth. The output set of teeth may mesh with at least one output planet gear. The at least one output planet gear may be rotatably coupled to a stationary output carrier so that the at least one output planet gear is rotatable about a third axis. The fixed component may connect to the stationary output carrier with a pilot that is received in a circumferential recess in the fixed component that is transverse to the primary axis. Further, the input carrier may include a distal central opening. The distal central opening may mateably receive an annular bearing. The annular bearing may mateably receive a stationary end cap assembly.

In yet another aspect, a method for centering a planetary gear system is disclosed. The method may include providing a planetary gear system that may include an input component having a primary axis and that may couple to an input sun gear. The input sun gear may mesh with at least one input planet gear that may rotatably couple to an input carrier. The input carrier may couple to the input component for rotation about the primary axis. The input carrier may further include a distal central opening. The at least one input planet gear may be meshed with an input set of teeth of a ring gear that surrounds the at least one input planet gear and the input carrier. The ring gear may include an output set of teeth that may mesh with at least one output planet gear. The at least one output planet gear may be rotatably coupled to a stationary output carrier that includes a pilot. The method may further include providing a fixed component with a circumferential recess that is transverse to the primary axis and that receives the pilot, thereby coupling the stationary output carrier to the fixed component. The method may further include inserting an annular bearing in the distal central opening of the input carrier, and inserting a stationary end cap assembly into the annular bearing.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a sectional view of a disclosed planetary gear system:

FIG. 2 is a partial sectional view of the planetary gear system disclosed in FIG. 1, particularly illustrating the coupling between the stationary component (e.g., a reaction hub) and the stationary output carrier for purposes of centering the planetary gear system;

FIG. 3 is a perspective view of a bushing that forms part of a an end cap assembly of the disclosed planetary gear system;

FIG. 4 is a perspective view of an annular bearing that mateably receives the bushing of FIG. 3 and that further engages the input carrier for purposes of centering the planetary gear system; and

FIG. 5 is a perspective end view of the planetary gear system shown in FIG. 1.

The drawings are not necessarily to scale and that the disclosed embodiments may be illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

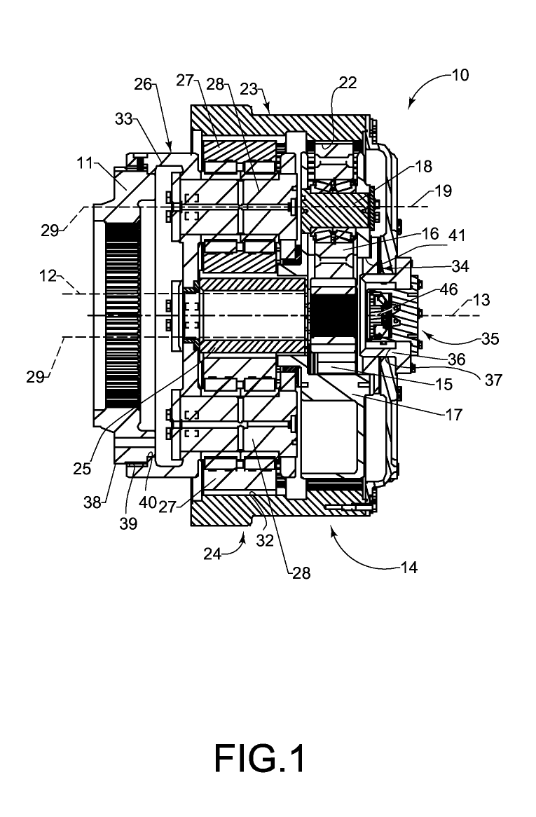

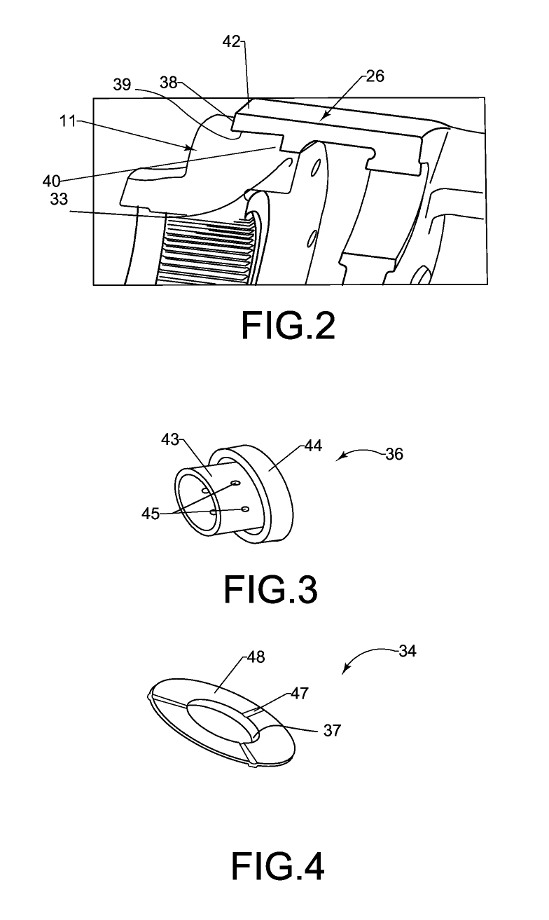

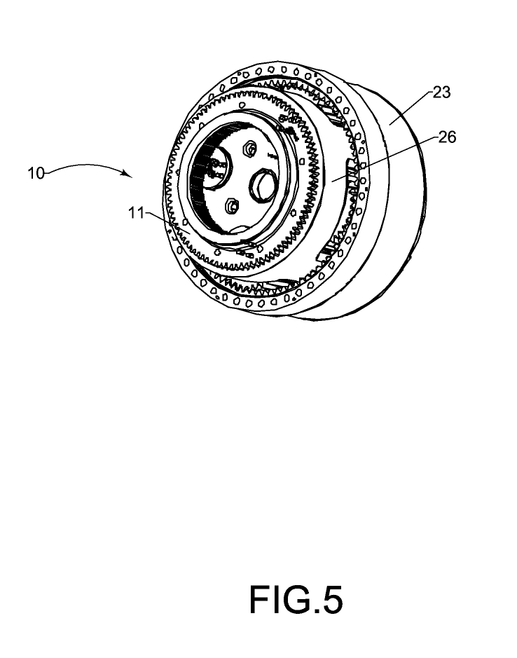

FIG. 1 is a sectional view of a disclosed planetary gear system 10. The planetary gear system 10 may either include or be coupled to a fixed component 11, such as a reaction hub. The fixed component 11 may connect to a spindle (not shown) or another stationary component. The fixed component 11 may connect to an axle shaft 12, which may be an input or drive shaft. The axle shaft 12 rotates about a primary axis 13. Further, the axle shaft 12 may couple to an input gear set 14, also known as a first reduction or first stage. The axle shaft 12 may connect directly or indirectly to the input gear set 14. The input gear set 14 may include an input sun gear 15 that rotates about the primary axis 13 with the axle shaft 12. The input sun gear 15 may mesh with one or more input planet gears 16. The one or more input planet gears 16 may couple to an input carrier 17 by way of a post 18. The input carrier 17 “floats” about the input sun gear 15. The post 18 permits the input planet gear 16 to rotate about the secondary axis 19. For those embodiments employing a plurality of input planet gears 16, each one of said input planet gears 16 would couple to the input carrier 17 in a similar fashion and be free to rotate about their own respective secondary axes 19. The input planet gear 16 may mesh with a set of input teeth 22 on the outer ring gear 23.

As the axle shaft 12 rotates, the input carrier 17 and input sun gear 15 rotate, thereby imparting rotation to the input planet gear 16, which will rotate and travel along the input teeth 22 of the outer ring gear 23. Therefore, the at least one input planet gear 16 rotates about its own respective secondary axis 19 as well as about the primary axis 13 as the input planet gear 16 rotates around input teeth 22 of the outer ring gear 23. The at least one input planet gear 16 also imparts rotation to the outer ring gear 23, but at a much slower rotational speed than the axle shaft 12.

The planetary gear system 10 also includes an output gear set 24 or second reduction. The output gear set 24 includes an output sun gear 25. The output sun gear 25 may couple via a floating connection to the input carrier 17. The output sun gear 25 “floats” about the axle shaft 12. The output sun gear 25 may mesh with one or more output planet gears 27. The output planet gears 27 may couple to the stationary output carrier 26 by posts 28 or another suitable means that permits rotation of the output planet gears 27 about their respective tertiary axes 29. The secondary and tertiary axes 19, 29 may be coaxial or offset from one another. The output planet gears 27 may mesh with output teeth 32 of the outer ring gear 23. Thus, the outer ring gear 23 may be equipped with input teeth 22 that may mesh with the one or more input planet gears 16 and output teeth 32 that may mesh with the one or more output planet gears 27. The output planet gears 27 may also mesh with the floating output sun gear 25.

As noted above, the fixed component 11 may be a reaction hub, which in turn, may connect to a spindle (not shown). To limit or prevent radial displacement of the input gear set 14 or output gear set 24, the stationary output carrier 26 secures to the fixed component 11. Specifically, the stationary output carrier 26 includes an inwardly extending pilot 40 that is received in a circumferential recess 33 that extends around the fixed component 11 to form a tongue in groove connection. Of course, the fixed component 11 could include a tongue or pilot 40 and the stationary output carrier 26 may include the circumferential recess 33. The coupling between the stationary output carrier 26 and the fixed component 11 prevents movement of the stationary output carrier 26 in a downward direction under the force of gravity when the planetary gear system 10 is stationary or rotating very slowly.

An additional feature is included to enhance the centering of the input gear set 14 and output gear set 24. Specifically, the floating input carrier 17 includes a distal central opening 41. The distal central opening 41 of the input carrier 17 accommodates an annular bearing 34. The annular bearing 34 receives a stationary end cap assembly 35, which may include a bushing 36. Similar to the tongue in groove connection between the stationary output carrier 26 and the fixed component 11, the engagement between the annular bearing 34 and the input carrier 17 prevents or inhibits sagging of the input gear set 14 under the force of gravity or if the planetary gear system 10 is moving very slowly. Thus, the annular bearing 34 includes a proximal annular section 37 (see FIG. 4) that provides a step while the distal central opening 41 provides a shoulder which engages the step-like structure of the proximal annular section 37 of the annular bearing 34.

Returning to the connection between the stationary output carrier 26 and the fixed component 11, the stationary output carrier 26 may include a proximal end 38 with radially inwardly facing splines 39 and, similarly, the fixed component 11 may include radially outwardly facing splines 42, which are used primarily for preventing axial movement of the gear sets 14, 24 along the primary axis 13.

As shown in FIG. 3, the bushing 36 includes a proximal annular section 43 and a distal flanged section 44. A plurality of holes or openings 45 are provided in the proximal annular section 43 for the passage of lubricant, specifically to the spherical roller thrust bearing 46 of the end cap assembly 35 (see FIG. 1). Similarly, as shown in FIG. 4, the annular bearing 34 also includes a proximal annular section 37 and a distal flange section 48. The distal flange section 48 may include at least one groove, slot or channel 47 for the passage of lubricant to the proximal annular section 43 of the bushing 36 thereby permitting the lubricant to pass through the openings 45 to the spherical roller thrust bearing 46.

### INDUSTRIAL APPLICABILITY

The drive arrangement between a hydraulic motor and a wheel of a vehicle or machine may include planetary gear systems 10 to reduce the rotational speeds between the axle shaft 12 and the wheel (not shown). Many planetary gear systems 10 include floating components, such as a floating output sun gear 25 and a floating input carrier 17. Such floating components can sag downwardly or radially when the planetary gear system 10 is at rest or rotating slowly. If the output sun gear 25 sags downward, there is a risk of unequal load sharing between the teeth of the output planet gear 27 and the output teeth 32 of the outer ring gear 23, which can lead to catastrophic gear failure. Similarly, any sagging of the input carrier 17 could cause unequal load sharing between the teeth of the input planet gear 16 and the input teeth 22 of the outer ring gear 23, which, again, can lead to catastrophic gear failure.

Disclosed herein is an improved means for maintaining the planetary gear system 10 in a centered position when not rotating or rotating very slowly. The disclosed planetary gear system 10 may be maintained in a centered position by using the fixed component 11, such as a reaction hub, to support the stationary output carrier 26. The output carrier 26 may include a pilot 40 that is received in a circumferential recess 33 of the fixed component 11 to provide a tongue in groove connection, which supports the output carrier 26 radially. Further, additional centering of the planetary gear system 10 may be provided by inserting an annular bearing 34 in the distal central opening 41 of the input carrier 17, and inserting a stationary end cap assembly 35 into the annular bearing 34. This supports the input carrier 17 and therefore the input planet gear 16 radially.

Accordingly, the coupling between the stationary output carrier 26 and the fixed component 11, which may be a reaction hub, a spindle, etc., and the use of the annular bearing 34, provides support for the planetary gear system 10 and helps prevent the input and output planet gears 16, 27 and/or the input and output carriers 17, 26 from sagging under the force of gravity. Such an uncentered condition can result in an uneven distribution of forces to the teeth of the various input and output planet gears 16, 27 respectively as well as the input and output teeth 22, 32 respectively of the outer ring gear 23. Hence, the disclosed planetary gear system 10 will be less prone to catastrophic gear or gear tooth failure, will result in a more even wearing of the gears and therefore may increase product life and reduce maintenance costs.

1. A planetary gear system connected to a fixed component, the planetary gear system comprising:
an input component having a primary axis and coupled to an input gear set, the input gear set meshed with an input set of teeth of a ring gear that surrounds the input gear set;
the ring gear including an output set of teeth, the output set of teeth meshed with at least one output planet gear, the at least one output planet gear rotatably coupled to a stationary output carrier; and
the stationary output carrier coupled to the fixed component with a tongue in groove connection that is transverse to the primary axis.

2. The planetary gear system of claim 1 wherein the fixed component includes a circumferential recess that extends around the fixed component and about the primary axis, the stationary output carrier includes a radially inwardly extending pilot that extends around the stationary output carrier and that is received in the circumferential recess of the fixed component.

3. The planetary gear system of claim 1 wherein the stationary output carrier further includes radially inwardly facing splines that extend around the stationary output carrier, and
the fixed component includes radially outwardly facing splines that extend around the fixed component and that enmesh with splines of the stationary output carrier.

4. The planetary gear system of claim 1 wherein the input gear set includes an input sun gear meshed with at least one input planet gear, the at least one input planet gear rotatably coupled to an input carrier, the input carrier including a distal central opening, the distal central opening receiving an annular bearing, the annular bearing receiving an end cap assembly.

5. The planetary gear system of claim 4 wherein the end cap assembly includes a bushing that is mateably received in the annular bearing.

6. The planetary gear system of claim 4 wherein the annular bearing includes at least one channel for communicating lubricant to the end cap assembly.

7. The planetary gear system of claim 5 wherein the bushing includes at least one opening for communicating lubricant to the end cap assembly, the end cap assembly including a spherical roller thrust bearing.

8. The planetary gear system of claim 4 wherein the annular bearing includes a proximal annular section that provides a step and the distal central opening of the input carrier that defines a shoulder, which engages the step of the annular bearing.

9. The planetary gear system of claim 1 wherein the fixed component is a reaction hub.

10. The planetary gear system of claim 1 wherein the fixed component is coupled to a spindle.

11. The planetary gear system of claim 2 wherein the input gear set includes an input sun gear meshed with at least one input planet gear, the at least one input planet gear rotatably coupled to an input carrier, the input carrier including a distal central opening, the distal central opening receiving an annular bearing, the annular bearing receiving a bushing of a stationary end cap assembly, the stationary end cap assembly including a spherical roller thrust bearing, the annular bearing and the bushing including at least one slot or opening for communicating lubricant to the spherical roller thrust bearing.

12. The planetary gear system of claim 1 wherein the at least one output planet gear further meshes with an output sun gear, the input component passing through the output sun gear.

13. A planetary gear system, comprising:
a fixed component;
an input component having a primary axis and coupled to an input sun gear, the input sun gear meshed with at least one input planet gear, the at least one input planet gear rotatably coupled to an input carrier, the at least one input planet gear rotatable about a secondary axis, the input carrier coupled to the input component for rotation about the primary axis, the at least one input planet gear meshed with an input set of teeth of a ring gear that surrounds the at least one input planet gear and the input carrier,
the ring gear including an output set of teeth, the output set of teeth meshed with at least one output planet gear, the at least one output planet gear rotatably coupled to a stationary output carrier so that the at least one output planet gear is rotatable about a third axis;
the fixed component connected to the stationary output carrier with a tongue and groove connection that is transverse to the primary axis; and
the input carrier including a distal central opening, the distal central opening mateably receiving an annular bearing, the annular bearing mateably receiving a stationary end cap assembly.

14. The planetary gear system of claim 13 wherein the stationary output carrier further includes radially inwardly facing splines that extends around the stationary output carrier, and
the fixed component includes radially outwardly facing splines that extends around the fixed component and that enmesh with splines of the stationary output carrier.

15. The planetary gear system of claim 13 wherein the fixed component includes a circumferential recess that extends around the fixed component and about the primary axis, and the stationary output carrier includes a radially inwardly extending pilot that extends around the stationary output carrier and that is received in the circumferential recess of the fixed component.

16. The planetary gear system of claim 13 wherein the annular bearing includes a proximal annular section that provides a step and the distal central opening of the input carrier defines a shoulder, which engages the step of the annular bearing.

17. The planetary gear system of claim 13 wherein the stationary end cap assembly includes a bushing that is mateably received in the annular bearing.

18. The planetary gear system of claim 13 wherein the fixed component is a reaction hub.

19. The planetary gear system of claim 13 wherein the reaction hub is coupled to a spindle.

20. A method for centering a planetary gear system, the method comprising:
providing a planetary gear system that includes an input component having a primary axis and coupled to an input sun gear, the input sun gear meshed with at least one input planet gear, the at least one input planet gear rotatably coupled to an input carrier, the input carrier coupled to the input component for rotation about the primary axis, the input carrier including a distal central opening, the at least one input planet gear meshed with an input set of teeth of a ring gear that surrounds the at least one input planet gear and the input carrier, the ring gear including a output set of teeth, the output set of teeth meshed with at least one output planet gear, the at least one output planet gear rotatably coupled to a stationary output carrier;
providing a fixed component with a tongue in groove connection that is transverse to the primary axis;
coupling the stationary output carrier to the fixed component;
inserting an annular bearing in the distal central opening of the input carrier; and
inserting a stationary end cap assembly into the annular bearing.
